(19) United States
(12) Patent Application Publication
(10) Pub. No.: US 2009/0183216 A1
(43) Pub. Date: Jul. 16, 2009

(54) Broadcast Television Distribution Services Architecture

(75) Inventor: Richard Crosby, Big Pine Key, FL (US)

Correspondence Address: LERNER GREENBERG STEMER LLP, P O BOX 2480, HOLLYWOOD, FL, 33022-2480, US

(73) Assignee: DIGITAL UTILITIES, INC., Liverpool, NY (US)

(21) Appl. No.: 12/262,845

(22) Filed: Oct. 31, 2008

Related U.S. Application Data
(60) Provisional application No. 60/984,220, filed on Oct. 31, 2007.

(51) Int. Cl. H04N 7/173

(52) U.S. Cl. 725/105; 725/116; 725/115

(57) ABSTRACT

A system for the distribution of live broadcast television content includes an encoding apparatus receiving a live broadcast television feed. The encoding apparatus includes a circuit matching network, a digital signal processor, a metadata generator, an MPEG multiplexer, an IP encapsulator, and an IP router. A centralized management facility or network operations center (NOC) is connected to the encoding apparatus. The management facility includes a diagnostics management system (DMS), automatic signal correction circuitry and software, an advertising database, a client database, and an authentication server. A decoding apparatus at a service client side receives the signal and decodes the same for feed supply to the client. The decoding apparatus includes one or more Ethernet ports, a metadata generator, MPEG demultiplexer, audio/video circuits, and a circuit matching network.

### CROSS-REFERENCE TO RELATED APPLICATION

This application claims the priority, under 35 U.S.C. § 119(e), of provisional application No. 60/984,220, filed Oct. 31, 2007; the prior application is herewith incorporated by reference in its entirety.

### BACKGROUND OF THE INVENTION

### Field of Invention

The invention lies in the field of communications. More specifically, the invention pertains to live television broadcast delivery systems and the various business flows obtainable.

The history of broadcast television delivery may be summarized as follows: Live broadcast television had its start in the late 1920s. Until 1948, the only way to receive video entertainment was via an antenna. A television broadcast was receivable for only 30 miles from the transmitter. In 1948 came the first multi-channel distribution technology, community antenna television, consisting of large antennae and RF wideband amplifiers. This extended the reception area up to 100 miles.

In mid 1950s to the early 1980s, terrestrial microwave extended the broadcasters' reach to the entire country, but the infrastructure was expensive, with considerable amounts of real estate required. Also, the signal itself was not consistent. From the 1980s until today, the method used for broadcast television distribution has been by way of geosynchronous satellites. This technique has given the broadcast a global reach. This comes at a price; to cover the entire globe requires a minimum of three satellites and four earth stations.

This is very expensive, beyond the reach of just about anybody but the major dozen networks. An import factor is in the process, different parametric conversions take place that results in a degraded signal the further down the chain the content is viewed.

It would be desireable to provide for a broadcasting system that allows for the delivery of any broadcast to any point at or near the quality generated at the studio, at a universally affordable price.

Internet video delivery may be summarized as follows: Video content delivery via the Internet traces its roots back to the early 1990s, with the systems MBONE, CUCMe and DARPA.

Content was and still is delivered for viewing on a computer monitor. What was postage stamp sized (80×60×4 fps) is now ⅓ of the monitor (320×240×15 fps). The substantially only change has been increased quality because of better available Internet access.

The main problem is still as it existed in the beginning. Internet video content is still being viewed on computer monitors. Broadcast Television content was meant to be enjoyed on a television or projection system in a comfortable manner usually in the company of others.

### BRIEF SUMMARY OF THE INVENTION

It is accordingly an object of the invention to provide a broadcast television distribution architecture system which overcomes the above-mentioned disadvantages of the heretofore-known devices and methods of this general type and which provides for a viable virtual cable television architecture. The system, methodology and business models of the invention, referred to herein as virtual cable television (VCT) provides the ability to provide subscription-based television services on a global and extra-terrestrial scale from a managed centralized facility (Network Operations Center, NOC) to a more conventional medium such as a television receiver or a newer medium such a cellular phone or PDA.

With the foregoing and other objects in view there is provided, in accordance with the invention, a live broadcast television delivery system, comprising:
a source of a live broadcast television feed;
an encoding apparatus receiving the broadcast television feed, said encoding apparatus including a circuit matching network, a digital signal processor, a metadata generator, an MPEG multiplexer, an IP encapsulator, and an IP router;
a centralized management facility, also referred to as a network operations center (NOC), connected to said encoding apparatus and including a diagnostics management system (DMS), automatic signal correction circuitry and software, an advertising database, a client database, and an authentication server; and
a decoding apparatus located at a service client side, said decoding apparatus including one or more Ethernet ports, a metadata generator, MPEG demultiplexer, audio/video circuits, and a circuit matching network.

In accordance with an added feature of the invention, the encoding apparatus is disposed at a location that is common with the source of the live broadcast television feed (i.e., directly at the TV production facility).

In accordance with an additional feature of the invention, the diagnostics management system (DMS) of the network operations center is configured to query all nodes on the network for metadata and content/data quality information.

In accordance with another feature of the invention, the diagnostics management system (DMS) is configured to insert data needed by a variety of correction algorithms of the system.

In accordance with a further feature of the invention, the diagnostics management system (DMS) is configured to:
initiate process and parametric changes at the encoding apparatus to compensate for various downstream conditions; and
compare encoder ports with decoder ports and adjust for optimal quality of experience (QoE.)

In accordance with an added feature of the invention, the network operations center is configured to remove advertising content from the live broadcast television feed and to store the advertising content in an advertising database for later insertion.

In accordance with an added feature of the invention, the network operations center is configured to process and route broadcast feeds based on business/client relationship algorithms.

According to the invention, the entire programming line-up is available from any point on the VCT network.

Initially, the first entity is enabled to acquire continuous or time-restricted video content directly from the broadcast facility by sampling and encoding the live feed including but not limited to, metadata and telemetry, directly from the source, typically a studio switcher or automation system. Next the first entity is enabled to IP encapsulate and route the content to the Network Operations Center.

The second entity comprises of authentication, security and processes to interpret all elements of the feed, including but not limited to picture information, metadata, and electrical elements.

The third entity determines whether the stream is of the service type to have advertising removed. If it is, the advertising is removed and sent to an advertising database for later use. The feed is then sent to the fifth entity (which can be located at the NOC or at a remote location) where the feeds are replicated, personalized, advertising inserted, and analysis preformed. The processed feed is then routed to the respected client to be rendered on a set top box or other type video rendering device.

If advertising is not to be removed, it is routed to the fourth entity, that is enabled, but not limited to analyze, replicate, decode, render and pass the feed on to the clients' equipment.

The entire distribution chain described is in constant communications at the network layer via the diagnostics management system, for the instantaneous improvement of the transported content but not limited to: encoding, routing, decoding, picture and sound quality.

Other features which are considered as characteristic for the invention are set forth in the appended claims.

Although the invention is illustrated and described herein as embodied in a broadcast television distribution services architecture, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic overview chart of the architecture according to the present invention;

FIG. 2 is a system flow chart relating to the acquisition, processing, and routing of broadcast content;

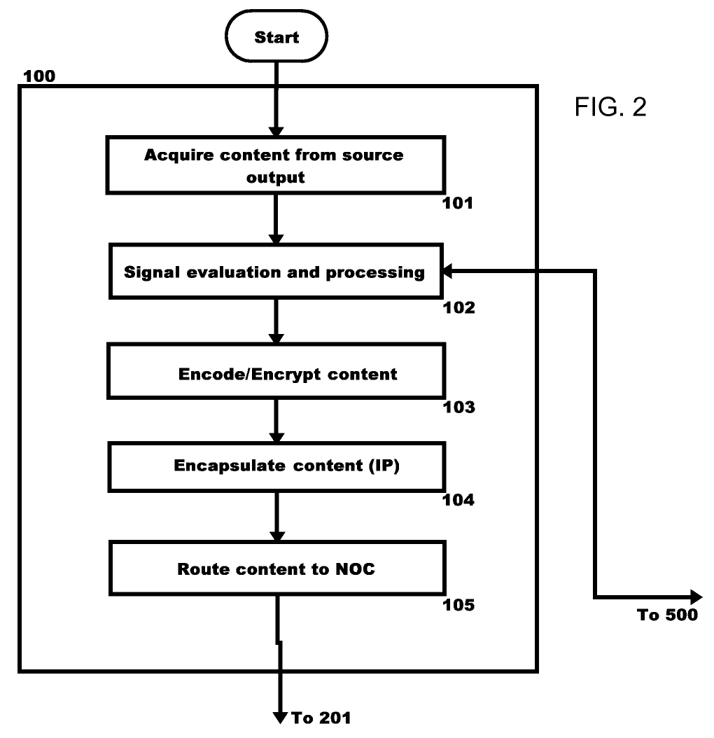

FIG. 3 is a flow chart and system diagram of the processes occurring at the NOC in relation to the content streams;

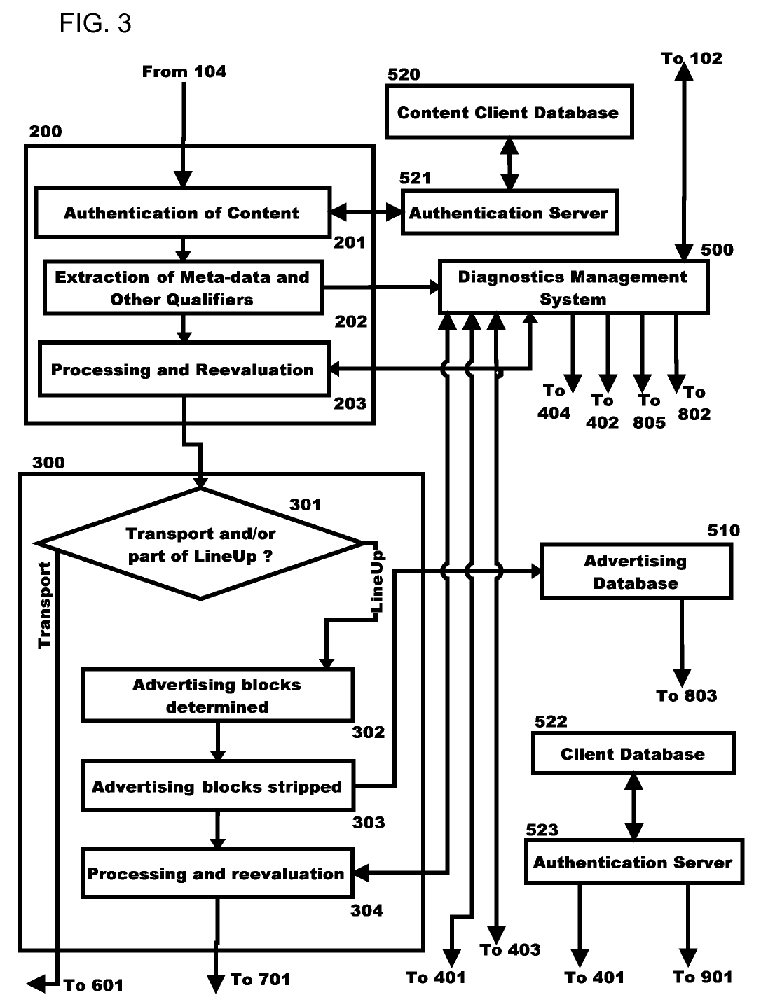

FIG. 4 is a system flow chart of the process from NOC to VCT transport client;

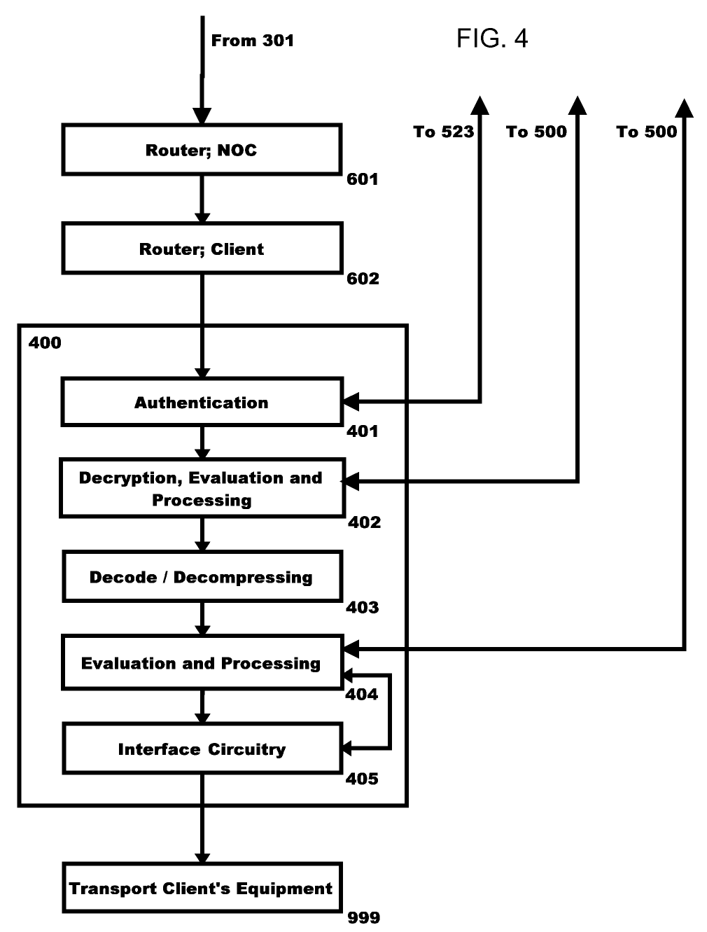

FIG. 5 is a system flow chart of the VCT subscription client processing occurring at a regional hub; and

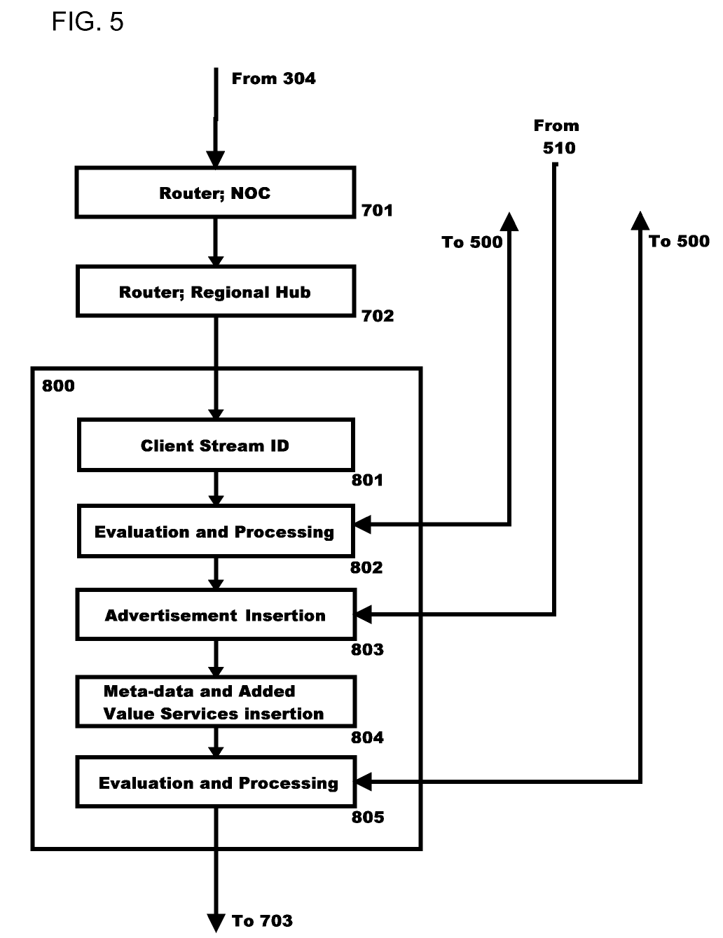

FIG. 6 is a system flow chart of the VCT subscription client end of the chain.

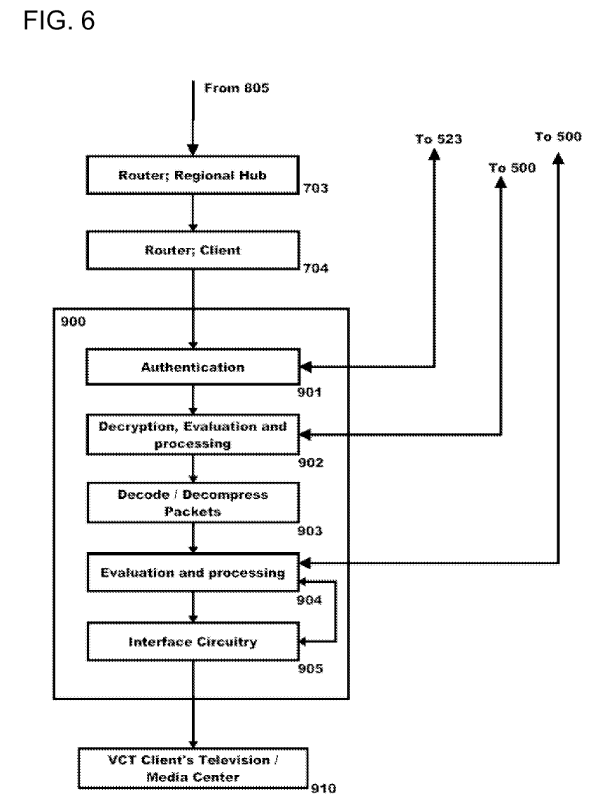

### DETAILED DESCRIPTION OF THE INVENTION

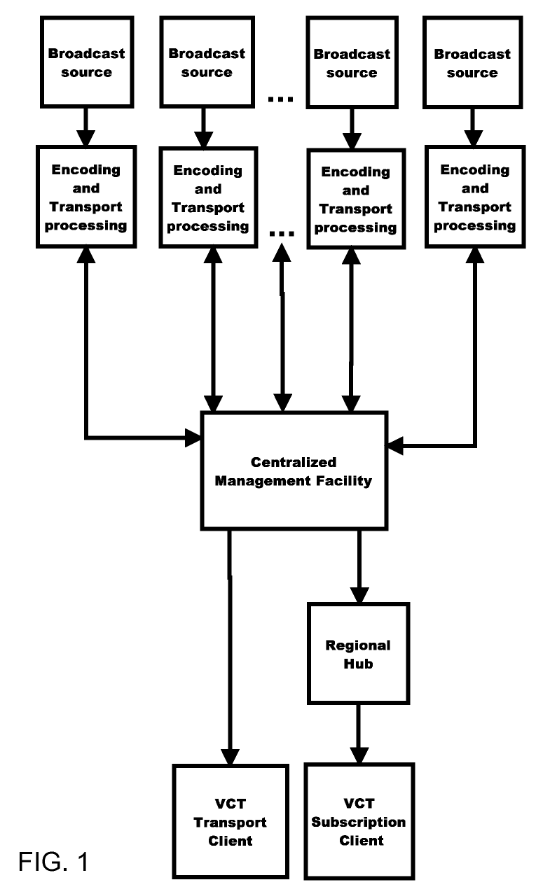

Referring now to the figures of the drawing in detail and first, particularly, to FIG. 1 thereof, the encoding device (100) acquires content from a broadcast television source such as a studio switcher, VTR, satellite receiver, or broadcast automation through the electrical or optical connection of the encoder input (101). The signal is then evaluated for integrity, composition, processed and meta-data generated and/or inserted (102).The encoder is in constant communications with the diagnostics management system (DMS) (500) for real time quality of service (QOS) abilities. The signal is then encoded, normally in a MPEG format for broadcasting standards compatibility, and then optionally encrypted for intellectual property protection (103). Next the feed is encapsulated to the IPv4 or IPv6 standard (104). It is then sent to the routing subsystem (105) for transport to the Centralized Management Facility (also referred to as the Network Operations Center or NOC.)

The feed is then authenticated (201) against an updated client database (520) served (521) to the first layer of the NOC (200.) Once authenticated, meta-data and diagnostics information is read (202) by the DMS (500) and adjusted data are reinserted into the feed and processing (if needed) is commenced (203.)

The feed is then sent to the service preparations layer (300) where the signal routed according to it services (301) transport and/or part of the Virtual Cable Television (VCT) lineup.

Transport service feeds are sent on the transport delivery receivers/decoder (400) via the public internet through the appropriate routers at the NOC (601) and at the client's location (602).

The feed is first authenticated the authentication server (523) then decrypted, and evaluated for QOS (402) through the DMS (500) and processed.

Next the feed is decoded (403) then evaluated against the DMS (500) and processed (if needed) (404).

It is the sent to the interface circuitry (405) for proper electromagnetic and or optical matching with the transport client's equipment (406).

VCT lineup feeds are analyzed for advertising blocks (302) which are stripped off (303). The feed is then processed for later advertising reinsertion and the reevaluated (304) by the diagnostics management system DMS (500) with adjustments to picture and data information. This feed is then sent over the public Internet (or other IP network) through the NOC router (701) to the regional hub router (702) which is connected to the Regional Hub (RB) where the feed is identified (801) then evaluated (802) against the DMS (500) and processed according to demographics. Next advertising is inserted (803) from the advertising server and or network (510). Then meta-data and other information such as text, sms, picture on picture, is inserted into the feed (804).

The feed is then reevaluated (805) against the diagnostics management system DMS (500) and processed (if needed).

The appropriate feed is then sent over the Internet through the RH router (703) and the client's router (704) to the set top box or like device (900). Authentication of the feed and level of allowed services are determined (901) against an updated client database (522) via the authentication server (523) if verified, is next decrypted (902), evaluated from the DMS (500) and processed (if needed.) Next signal is decoded (903) then the content reevaluated (904) by the DMS (500) and processed (if needed.) The feed is then sent on to the output interface circuitry (905) then out to the client's television or like device (999).

1. A live broadcast television delivery system, comprising:
an encoding apparatus connected to a source of a live broadcast television feed and receiving the broadcast television feed, said encoding apparatus including a circuit matching network, a digital signal processor, a metadata generator, an MPEG multiplexer, an IP encapsulator, and an IP router;
a centralized management facility (NOC) connected to said encoding apparatus and including a diagnostics management system (DMS), automatic signal correction circuitry and software, an advertising database, a client database, and an authentication server; and
a decoding apparatus located at a service client side, said decoding apparatus including one or more Ethernet ports, a metadata generator, MPEG demultiplexer, audio/video circuits, and a circuit matching network.

2. The system according to claim 1, wherein said encoding apparatus is disposed at a location common with the source of the live broadcast television feed.

3. The system according to claim 1, wherein said diagnostics management system (DMS) of said NOC is configured to query all nodes on the network for metadata and content/data quality information.

4. The system according to claim 1, wherein said diagnostics management system (DMS) is configured to insert data needed by a variety of correction algorithms of the system.

5. The system according to claim 1, wherein said diagnostics management system (DMS) is configured to:
initiate process and parametric changes at the encoding apparatus to compensate for various downstream conditions; and
compare encoder ports with decoder ports and adjust for optimal quality of experience (QoE.)

6. The system according to claim 1, wherein said NOC is configured to remove advertising content from the live broadcast television feed and to store the advertising content in an advertising database for later insertion.

7. The system according to claim 1, wherein said NOC is configured to process and route broadcast feeds based on business/client relationship algorithms.
